(19) United States
(12) Patent Application Publication
(10) Pub. No.: US 2026/0253097 A1
(43) Pub. Date: Aug. 27, 2026

(54) METHOD AND APPARATUS FOR A VALUE TRACK FEATURE OF A CENTRALIZED TRAVEL PROGRAM MANAGEMENT SYSTEM

(71) Applicant: Airlines Reporting Corporation, Arlington, VA (US)

(72) Inventors: Michael Harbin, Chicago, IL (US); Rich Hunt, Ossining, NY (US)

(73) Assignee: Airlines Reporting Corporation, Arlington, VA (US)

(21) Appl. No.: 19/532,622

(22) Filed: Feb. 6, 2026

Related U.S. Application Data
(63) Continuation-in-part of application No. 17/478,082, filed on Sep. 17, 2021.
(60) Provisional application No. 63/080,912, filed on Sep. 21, 2020.
(60) Provisional application No. 63/755,338, filed on Feb. 7, 2025.

(51) Int. Cl. G06Q 30/0207; G06Q 10/02

(52) U.S. Cl. CPC G06Q 30/0207; G06Q 10/02

(57) ABSTRACT

A value track feature of a centralized travel program management system is disclosed. The value track feature of the centralized travel program management system comprises at least one processor configured to receive, event-driven booking data; parse and normalize, the event-driven booking data to generate a standardized unused travel value object; store the standardized unused travel value object in a centralized value ledger; determine traveller identity data, and organizational group membership, a set of eligible candidate travellers within an enterprise; execute an allocation determination process configured to automatically rank and select, from the set of eligible candidate travellers, a candidate traveller; assign the standardized unused travel value object to the selected candidate traveller by updating the centralized value ledger without exposing supplier-originated credit identifiers or redemption credentials to the selected candidate traveller; determine traveller eligibility for use of the assigned standardized unused travel value object; and transmit the assigned standardized unused travel value object to a checkout system of the at least one travel supplier system.

### CROSS REFERENCE TO RELATED APPLICATION

This non-provisional patent application claims the benefit under 35 U.S.C. § 199(e) of U.S. Provisional Patent Application Ser. No. 63/755,338, filed Feb. 7, 2025, and also claims the benefit under 35 U.S.C. § 120 as a continuation-in-part patent application of U.S. patent application Ser. No. 17/478,082, filed Sep. 17, 2021, which claims the benefit under 35 U.S.C. § 199(e) of U.S. Provisional Patent Application Ser. No. 63/080,912, filed Sep. 21, 2020 (and the Appendixes/Attachments filed therewith), the disclosures of each of which are all incorporated herein by reference.

### TECHNOLOGICAL FIELD OF INVENTION

The present invention is directed to a method and apparatus for a value track feature of a centralized travel program management system, and more particularly to an unused value and wallet integration product that will enable suppliers to track and manage (capture, report, allocate, assign, transfer, apply/redeem/forfeit) value that is unused by a traveller and transfer the unused value between travellers and/or to the organization for reassignment and use.

### BACKGROUND OF THE INVENTION

In existing travel booking environments, travellers who book directly with travel suppliers, such as airlines, may receive unused ticket value, credits, or other forms of residual value when a booking is cancelled, modified, or otherwise disrupted. In many instances, responsibility for tracking and using such unused value rests primarily with the individual traveller. Consequently, unused travel value is frequently forgotten, misplaced, or allowed to expire without being applied to future travel, particularly in enterprise or corporate travel settings involving multiple travellers and numerous bookings.

Further, when travel suppliers permit unused travel value to be transferred or reassigned to other travellers, such transfers are typically executed through manual processes. For example, travellers may be required to share credit details with travel managers or other individuals, who must then manually track, record, and apply such information for future bookings. These manual approaches are time-consuming, error-prone, and difficult to scale across organizations with large traveller populations or frequent booking changes. In many cases, travel managers lack a consolidated view of unused travel value across travellers, thereby limiting the ability to determine available value, applicable expiration dates, or eligible recipients.

Additionally, conventional approaches for handling unused travel value often rely on fragmented systems that do not effectively integrate data from travel supplier platforms with enterprise travel management processes. As a result, unused travel value may remain isolated within individual traveller accounts or supplier systems, thereby limiting organizational-level visibility and reuse. In certain instances, sensitive credit information must be manually communicated or re-entered during booking, increasing the risk of unauthorized use or misuse outside approved corporate travel channels. Accordingly, there exists a need for improved systems and methods that address one or more of the foregoing deficiencies associated with tracking, managing, and utilizing unused travel value in enterprise travel environments.

### SUMMARY OF THE INVENTION

The following presents a summary of some example embodiments to provide a basic understanding of some aspects of the present disclosure. This summary is not an extensive overview and is intended to neither identify key or critical elements nor delineate the scope of such elements. It will also be appreciated that the scope of the disclosure encompasses many potential embodiments in addition to those here summarized, some of which will be further described in the detailed description that is presented later.

In an example embodiment, an apparatus of a value track feature of a centralized travel program management system is disclosed. The value track feature comprises a memory configured to store one or more instructions; and at least one processor communicatively coupled to the memory, wherein the at least one processor, when executing the one or more instructions, is configured to receive, via one or more application programming interfaces, event-driven booking data from at least one travel supplier system, the event-driven booking data being generated in response to a travel booking creation, modification, cancellation, or partial fulfilment; parse and normalize, using a supplier-agnostic data processing module, the event-driven booking data to generate a standardized unused travel value object comprising at least a monetary value, expiration data, traveller identification data, enterprise association data, and supplier-specific usage constraints; store the standardized unused travel value object in a centralized value ledger maintained in the memory, wherein the centralized value ledger is a continuously synchronized data structure configured to track a lifecycle state of each standardized unused travel value object comprising at least available, assigned, consumed, expired, or forfeited states; determine, based at least on enterprise policy rules, traveller identity data, and organizational group membership, a set of eligible candidate travellers within an enterprise for assignment of the standardized unused travel value object; execute, using a machine-learning based allocation engine, an allocation determination process configured to automatically rank and select, from the set of eligible candidate travellers, a candidate traveller for assignment of the standardized unused travel value object based on predicted utilization and expiration avoidance; assign the standardized unused travel value object to the selected candidate traveller by updating the centralized value ledger without exposing supplier-originated credit identifiers or redemption credentials to the selected candidate traveller, thereby enforcing enterprise-only usage and preventing unauthorized external transfer; determine, in real time and prior to a checkout transaction, traveller eligibility for use of the assigned standardized unused travel value object by applying an authorization model that evaluates traveller identity data, enterprise policy rules, booking channel attributes, and the supplier-specific usage constraints associated with the standardized unused travel value object; and transmit, upon determining traveller eligibility, the assigned standardized unused travel value object to a checkout system of the at least one travel supplier system during a booking workflow such that the standardized unused travel value object is automatically surfaced and applied during checkout without requiring manual credit entry by the traveller.

In some embodiments, the machine-learning based allocation engine is trained using historical unused travel value consumption data, expiration data, and traveller booking behaviour data.

In some embodiments, determining the set of eligible candidate travellers comprises excluding travellers outside the enterprise associated with the standardized unused travel value object.

In some embodiments, determining the set of eligible candidate travellers is based further on at least one of traveller employment status, organizational unit, department code, cost center, or enterprise policy tier.

In some embodiments, the set of eligible candidate travellers is dynamically updated in response to changes in enterprise policy rules or traveller status data.

In some embodiments, assigning the standardized unused travel value object causes the centralized value ledger to update the lifecycle state from available to assigned.

In some embodiments, assigning the standardized unused travel value object comprises locking the standardized unused travel value object to a single selected candidate traveller to prevent concurrent redemption.

In some embodiments, the standardized unused travel value object is associated with an internal token that replaces supplier-originated credit identifiers during storage and transmission.

In some embodiments, application of the standardized unused travel value object during checkout is designated as mandatory or optional based on enterprise policy rules.

In some embodiments, the at least one processor executing the one or more instructions, is configured to detect, via a transactional feedback interface, consumption of the standardized unused travel value object during completion of the booking workflow.

In some embodiments, detecting consumption causes the centralized value ledger to update the lifecycle state to consumed.

In some embodiments, the updated lifecycle state is propagated in real time to an enterprise administration system and the at least one travel supplier system to maintain synchronized credit state consistency across distributed computing environments.

In some embodiments, real-time propagation of lifecycle state changes reduces data inconsistency across distributed computing systems associated with the enterprise and the at least one travel supplier system.

In some embodiments, the centralized value ledger operates as a single source of truth for standardized unused travel value objects across a plurality of travel supplier systems.

In another example embodiment, a method for a value track feature of a centralized travel program management system is disclosed. The method comprises steps of receiving, via at least one processor communicatively coupled to a memory, event-driven booking data from at least one travel supplier system, using one or more application programming interfaces, the event-driven booking data being generated in response to a travel booking creation, modification, cancellation, or partial fulfilment; parsing and normalizing, via at least one processor, the event-driven booking data to generate a standardized unused travel value object comprising at least a monetary value, expiration data, traveller identification data, enterprise association data, and supplier-specific usage constraints, using a supplier-agnostic data processing module; storing, via the at least one processor, the standardized unused travel value object in a centralized value ledger maintained in the memory, wherein the centralized value ledger is a continuously synchronized data structure configured to track a lifecycle state of each standardized unused travel value object comprising at least available, assigned, consumed, expired, or forfeited states; determining, via the at least one processor, based at least on enterprise policy rules, traveller identity data, and organizational group membership, a set of eligible candidate travellers within an enterprise for assignment of the standardized unused travel value object; executing, via the at least one processor, an allocation determination process configured to automatically rank and select, from the set of eligible candidate travellers, a candidate traveller for assignment of the standardized unused travel value object based on predicted utilization and expiration avoidance, using a machine-learning based allocation engine; assigning, via the at least one processor, the standardized unused travel value object to the selected candidate traveller by updating the centralized value ledger without exposing supplier-originated credit identifiers or redemption credentials to the selected candidate traveller, thereby enforcing enterprise-only usage and preventing unauthorized external transfer; determining, via the at least one processor, in real time and prior to a checkout transaction, traveller eligibility for use of the assigned standardized unused travel value object by applying an authorization model that evaluates traveller identity data, enterprise policy rules, booking channel attributes, and the supplier-specific usage constraints associated with the standardized unused travel value object; and transmitting, via the at least one processor, upon determining traveller eligibility, the assigned standardized unused travel value object to a checkout system of the at least one travel supplier system during a booking workflow such that the standardized unused travel value object is automatically surfaced and applied during checkout without requiring manual credit entry by the traveller.

In another example embodiment, a computer program system, comprising a non-transitory computer usable medium having a computer readable program code therein, the computer readable program code adapted to be executed for the value track feature of the centralized travel program management system, the method comprising receiving, via at least one processor communicatively coupled to a memory, event-driven booking data from at least one travel supplier system, using one or more application programming interfaces, the event-driven booking data being generated in response to a travel booking creation, modification, cancellation, or partial fulfilment; parsing and normalizing, via at least one processor, the event-driven booking data to generate a standardized unused travel value object comprising at least a monetary value, expiration data, traveller identification data, enterprise association data, and supplier-specific usage constraints, using a supplier-agnostic data processing module; storing, via the at least one processor, the standardized unused travel value object in a centralized value ledger maintained in the memory, wherein the centralized value ledger is a continuously synchronized data structure configured to track a lifecycle state of each standardized unused travel value object comprising at least available, assigned, consumed, expired, or forfeited states; determining, via the at least one processor, based at least on enterprise policy rules, traveller identity data, and organizational group membership, a set of eligible candidate travellers within an enterprise for assignment of the standardized unused travel value object; executing, via the at least one processor, an allocation determination process configured to automatically rank and select, from the set of eligible candidate travellers, a candidate traveller for assignment of the standardized unused travel value object based on predicted utilization and expiration avoidance, using a machine-learning based allocation engine; assigning, via the at least one processor, the standardized unused travel value object to the selected candidate traveller by updating the centralized value ledger without exposing supplier-originated credit identifiers or redemption credentials to the selected candidate traveller, thereby enforcing enterprise-only usage and preventing unauthorized external transfer; determining, via the at least one processor, in real time and prior to a checkout transaction, traveller eligibility for use of the assigned standardized unused travel value object by applying an authorization model that evaluates traveller identity data, enterprise policy rules, booking channel attributes, and the supplier-specific usage constraints associated with the standardized unused travel value object; and transmitting, via the at least one processor, upon determining traveller eligibility, the assigned standardized unused travel value object to a checkout system of the at least one travel supplier system during a booking workflow such that the standardized unused travel value object is automatically surfaced and applied during checkout without requiring manual credit entry by the traveller.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a network diagram for a centralized travel value management system in accordance with an example embodiment of the present disclosure;

FIG. 2 illustrates a block diagram of the server in accordance with an example embodiment of the present disclosure;

FIG. 3 illustrates an example interaction flow between multiple systems involved in an enterprise travel booking lifecycle in accordance with an example embodiment of the present disclosure;

FIG. 4 illustrates an example value-tracking interaction flow associated with management of standardized unused travel value objects within an enterprise travel environment in accordance with an example embodiment of the present disclosure;

FIG. 5 illustrates an example administrative user interface for managing standardized unused travel value objects within an enterprise travel environment in accordance with an example embodiment of the present disclosure;

FIG. 6 illustrates an example assignment interface presented within the administrative user interface in accordance with an example embodiment of the present disclosure;

FIG. 7 illustrates an example unassignment confirmation dialog displayed within the administrative user interface in accordance with an example embodiment of the present disclosure; and

FIG. 8 illustrates a flowchart showing a method for a value track feature of a centralized travel program management system in accordance with an example embodiment of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the present disclosure described herein such that embodiments may include fewer or more components than those shown in the figures while not departing from the scope of the present disclosure. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The present disclosure provides various embodiments of a value track feature of a centralized travel program management system. The embodiments of the value track feature of the centralized travel program management system comprises at least one processor communicatively coupled to a memory and is configured to receive, via one or more application programming interfaces, event-driven booking data from at least one travel supplier system, the event-driven booking data being generated in response to a travel booking creation, modification, cancellation, or partial fulfilment; parse and normalize, using a supplier-agnostic data processing module, the event-driven booking data to generate a standardized unused travel value object comprising at least a monetary value, expiration data, traveller identification data, enterprise association data, and supplier-specific usage constraints; store the standardized unused travel value object in a centralized value ledger maintained in the memory, wherein the centralized value ledger is a continuously synchronized data structure configured to track a lifecycle state of each standardized unused travel value object comprising at least available, assigned, consumed, expired, or forfeited states; determine, based at least on enterprise policy rules, traveller identity data, and organizational group membership, a set of eligible candidate travellers within an enterprise for assignment of the standardized unused travel value object; execute, using a machine-learning based allocation engine, an allocation determination process configured to automatically rank and select, from the set of eligible candidate travellers, a candidate traveller for assignment of the standardized unused travel value object based on predicted utilization and expiration avoidance; assign the standardized unused travel value object to the selected candidate traveller by updating the centralized value ledger without exposing supplier-originated credit identifiers or redemption credentials to the selected candidate traveller, thereby enforcing enterprise-only usage and preventing unauthorized external transfer; determine, in real time and prior to a checkout transaction, traveller eligibility for use of the assigned standardized unused travel value object by applying an authorization model that evaluates traveller identity data, enterprise policy rules, booking channel attributes, and the supplier-specific usage constraints associated with the standardized unused travel value object; and transmit, upon determining traveller eligibility, the assigned standardized unused travel value object to a checkout system of the at least one travel supplier system during a booking workflow such that the standardized unused travel value object is automatically surfaced and applied during checkout without requiring manual credit entry by the traveller.

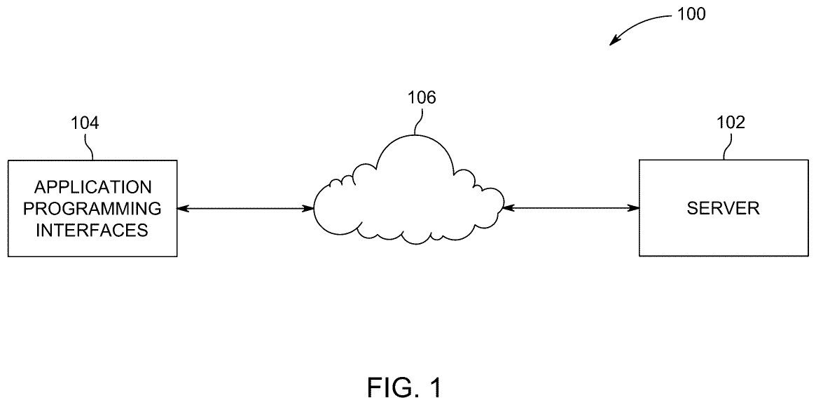

FIG. 1 illustrates a network diagram for a centralized travel value management system 100, in accordance with an example embodiment of the present disclosure. In some embodiments, the centralized travel value management system 100 comprises a server 102, one or more application programming interfaces 104, and network 106. In some embodiments, the server 102 comprises at least one processor communicatively coupled to a memory. The memory of the server 102 is configured to store one or more instructions that, when executed by the at least one processor, cause the server 102 to perform operations associated with centralized travel value management. The server 102 may be implemented as a single computing device or as a distributed computing system comprising a plurality of computing devices operating together. The at least one processor may include one or more general-purpose processors, special-purpose processors, or a combination thereof, and the memory may include one or more non-transitory computer-readable storage media. The server 102 is communicatively coupled to the network 106 and is configured to exchange data with one or more external systems via the one or more application programming interfaces 104.

In some embodiments, the server 102 may be configured to receive, via the one or more application programming interfaces 104, event-driven booking data from at least one travel supplier system, the event-driven booking data being generated in response to a travel booking creation, modification, cancellation, or partial fulfilment. In some embodiments, the event-driven booking data corresponds to data payloads that are transmitted in response to specific booking-related events occurring within a travel supplier system, rather than through periodic polling or manual data submission. Such event-driven booking data may be generated automatically when a travel booking is created, modified, cancelled, or partially fulfilled, and may include structured information reflecting changes to a booking state.

In some example embodiments, the event-driven booking data may include identifiers associated with a booking, one or more travellers, itinerary details, payment or fare information, and indicators of unused or residual value resulting from the booking-related event. The use of the one or more application programming interfaces 104 enables standardized, programmatic communication between the server 102 and external systems, allowing the event-driven booking data to be transmitted in real time or near real time over the network 106 as the corresponding booking events occur, thereby reducing latency and avoiding reliance on manual intervention or batch-based data exchange mechanisms.

In some embodiments, the server 102 may be configured to parse and normalize the event-driven booking data to generate a standardized unused travel value object comprising at least a monetary value, expiration data, traveller identification data, enterprise association data, and supplier-specific usage constraints. In some embodiments, parsing the event-driven booking data includes analyzing structured or semi-structured data fields received via the one or more application programming interfaces 104 to identify information relevant to unused travel value resulting from a booking-related event. Normalization may include transforming the identified information into a common internal representation that is independent of data formats, schemas, or conventions used by different travel supplier systems.

Through such normalization, disparate booking data originating from different travel suppliers may be converted into a consistent data structure suitable for subsequent processing. The standardized unused travel value object may encapsulate multiple attributes associated with the unused travel value, including a monetary value corresponding to an amount eligible for reuse, expiration data indicating a time period during which the unused travel value remains valid, traveller identification data identifying a traveller associated with the unused travel value, enterprise association data identifying an enterprise context applicable to the unused travel value, and supplier-specific usage constraints defining conditions under which the unused travel value may be applied.

In one example embodiment, event-driven booking data generated in response to a booking cancellation may include fare details, refund indicators, and booking identifiers provided by a travel supplier system in a supplier-specific format. The server 102 may normalize such data by mapping the supplier-specific fields to a standardized unused travel value object that expresses the unused travel value as a monetary amount, associates the unused travel value with a corresponding traveller and enterprise, identifies an expiration date imposed by the travel supplier, and captures any supplier-specific restrictions on how the unused travel value may be used. This standardized representation enables unused travel value derived from different travel supplier systems to be handled in a uniform manner without requiring downstream processing logic to account for supplier-specific data variations.

Further, the server 102 may be configured to store the standardized unused travel value object in a centralized value ledger maintained in the memory. The centralized value ledger is a continuously synchronized data structure configured to track a lifecycle state of each standardized unused travel value object comprising at least available, assigned, consumed, expired, or forfeited states. In some embodiments, the centralized value ledger serves as a logical repository for maintaining state information associated with standardized unused travel value objects over time. The centralized value ledger may be implemented using one or more data structures stored in the memory of the server 102 and may be configured to maintain an up-to-date representation of the current lifecycle state of each standardized unused travel value object. Continuous synchronization of the centralized value ledger enables changes to lifecycle states to be reflected consistently as booking-related events occur or as the standardized unused travel value objects are subsequently processed. By maintaining lifecycle state information within the centralized value ledger, the server 102 is able to distinguish between standardized unused travel value objects that are available for potential use, those that have been assigned, those that have been consumed during a booking workflow, those that have expired without use, and those that have been forfeited due to applicable conditions.

In one example embodiment, when a standardized unused travel value object is initially generated and stored, the centralized value ledger may record the lifecycle state as available. Upon subsequent updates, the lifecycle state associated with the standardized unused travel value object may be transitioned to assigned, consumed, expired, or forfeited based on corresponding events or conditions. The centralized value ledger may retain historical state information or timestamps associated with such transitions to support accurate tracking of unused travel value over its lifecycle. This centralized tracking approach allows lifecycle state information for standardized unused travel value objects to be maintained in a consistent and unified manner without requiring reliance on disparate external records.

Further, the server 102 may be configured to determine, based at least on enterprise policy rules, traveller identity data, and organizational group membership, a set of eligible candidate travellers within an enterprise for assignment of the standardized unused travel value object. In some embodiments, determining the set of eligible candidate travellers involves evaluating information associated with an enterprise context to identify travellers who satisfy predefined eligibility conditions applicable to the standardized unused travel value object. Such eligibility conditions may be defined by enterprise policy rules that specify which travellers or groups of travellers are permitted to receive unused travel value, and may further take into account traveller identity data and organizational group membership associated with the enterprise. The resulting set of eligible candidate travellers represents a constrained subset of travellers within the enterprise that are permitted to be considered for assignment of the standardized unused travel value object, thereby excluding travellers who do not satisfy applicable enterprise-defined conditions.

In one example embodiment, enterprise policy rules may specify that only travellers associated with a particular department, business unit, cost center, or organizational group are eligible to receive unused travel value generated from certain bookings. The server 102 may apply such policy rules in combination with traveller identity data to identify travellers that belong to the specified organizational group, and may exclude travellers that fall outside the defined enterprise scope. By determining the set of eligible candidate travellers in this manner, the server 102 ensures that subsequent processing of the standardized unused travel value object is constrained to travellers that are authorized within the enterprise context, without yet performing selection or assignment of the standardized unused travel value object.

Further, the server 102 may be configured to execute an allocation determination process configured to automatically rank and select, from the set of eligible candidate travellers, a candidate traveller for assignment of the standardized unused travel value object based on predicted utilization and expiration avoidance. In some embodiments, the allocation determination process operates on the previously determined set of eligible candidate travellers to evaluate relative suitability for assignment of the standardized unused travel value object. The allocation determination process may take into account predicted utilization characteristics and expiration-related factors associated with the standardized unused travel value object, enabling comparative assessment among the eligible candidate travellers. By ranking eligible candidate travellers according to such predictive considerations, the server 102 is able to identify a candidate traveller that is more likely to utilize the standardized unused travel value object prior to expiration. The selection performed by the allocation determination process is distinct from the determination of eligibility and is directed toward optimizing assignment outcomes within the constraints established by enterprise policy rules.

In one example embodiment, predicted utilization may be derived from historical booking behavior, prior usage patterns, or other data indicative of a traveller's likelihood of applying unused travel value within a given time period. Expiration avoidance may be reflected by prioritizing assignment of the standardized unused travel value object to a candidate traveller whose predicted booking activity aligns with the remaining validity period of the unused travel value. By automatically ranking and selecting a candidate traveller in this manner, the server 102 enables assignment decisions to be informed by predictive considerations while remaining constrained to the set of eligible candidate travellers previously determined.

Further, the server 102 may be configured to assign the standardized unused travel value object to the selected candidate traveller by updating the centralized value ledger without exposing supplier-originated credit identifiers or redemption credentials to the selected candidate traveller, thereby enforcing enterprise-only usage and preventing unauthorized external transfer. In some embodiments, assigning the standardized unused travel value object includes associating the standardized unused travel value object with the selected candidate traveller within the centralized value ledger such that subsequent processing reflects the association without altering the underlying unused travel value itself. Updating the centralized value ledger in this manner enables the server 102 to represent assignment as a state-based relationship rather than through transfer of supplier-originated credit data. By avoiding exposure of supplier-originated credit identifiers or redemption credentials, the assignment is enforced at the system level, thereby ensuring that the standardized unused travel value object remains bound to the enterprise context and is not directly accessible or transferable by the selected candidate traveller outside the controlled system environment.

In one example embodiment, upon selection of a candidate traveller, the centralized value ledger may record an association between the standardized unused travel value object and an identifier corresponding to the selected candidate traveller while retaining supplier-originated credit identifiers solely within the server 102. The selected candidate traveller may therefore be designated as an assignee of the standardized unused travel value object without receiving visibility into, or control over, the underlying credit credentials. This approach prevents the standardized unused travel value object from being shared, forwarded, or applied outside approved enterprise workflows, and supports enterprise-only usage by maintaining control of assignment and redemption at the centralized system level.

Further, the server 102 may be configured to determine, in real time and prior to a checkout transaction, traveller eligibility for use of the assigned standardized unused travel value object by applying an authorization model that evaluates traveller identity data, enterprise policy rules, booking channel attributes, and the supplier-specific usage constraints associated with the standardized unused travel value object. In some embodiments, determining traveller eligibility is performed as a real-time evaluation that occurs after assignment of the standardized unused travel value object and before application of the unused travel value during a checkout transaction. The authorization model operates as an enforcement mechanism that validates whether the assigned standardized unused travel value object may be used under current conditions, taking into account attributes associated with the traveller, the enterprise context, and the booking environment. By performing this evaluation prior to checkout, the server 102 ensures that use of the standardized unused travel value object complies with applicable enterprise policy rules and supplier-specific usage constraints at the time of attempted use, rather than solely at the time of assignment.

In one example embodiment, the authorization model may evaluate whether the traveller attempting to use the standardized unused travel value object matches the traveller to whom the unused travel value was assigned, whether the booking transaction is occurring through an enterprise-approved booking channel, and whether the standardized unused travel value object remains valid under supplier-imposed conditions such as route restrictions, fare class limitations, or temporal constraints. If the evaluated conditions are satisfied, the standardized unused travel value object may be permitted for use during the checkout transaction. If one or more conditions are not satisfied, use of the standardized unused travel value object may be restricted or denied, thereby preventing unauthorized or non-compliant application of the unused travel value.

Further, the server 102 may be configured to transmit, upon determining traveller eligibility, the assigned standardized unused travel value object to a checkout system of the at least one travel supplier system during a booking workflow such that the standardized unused travel value object is automatically surfaced and applied during checkout without requiring manual credit entry by the traveller. In some embodiments, transmitting the assigned standardized unused travel value object enables the server 102 to make the unused travel value available to the checkout system in a programmatic manner during an active booking workflow. Such transmission may occur through the one or more application programming interfaces 104 and is performed after successful completion of the authorization evaluation. Automatic surfacing of the standardized unused travel value object at checkout allows the checkout system to recognize the availability of the unused travel value and to present or apply the unused travel value in association with the booking transaction without requiring manual input of credit identifiers, codes, or credentials by the traveller. This automated interaction reduces dependency on traveller-managed information and supports consistent application of unused travel value within enterprise-controlled booking workflows.

In one example embodiment, when a traveller proceeds to check out for a new booking, the server 102 may transmit information corresponding to the assigned standardized unused travel value object to the checkout system such that the unused travel value is automatically reflected in the booking transaction. The checkout system may apply the unused travel value as a reduction to a booking amount or otherwise incorporate the unused travel value into the transaction according to supplier-defined behavior, without exposing underlying supplier-originated credit data to the traveller. By enabling automated surfacing and application of the standardized unused travel value object at checkout, the server 102 facilitates seamless use of unused travel value while maintaining control and compliance within the enterprise context.

It should be understood that FIG. 1 is provided for purposes of illustration only and is not intended to limit the scope of the present disclosure. The arrangement, number, and interconnection of components shown in FIG. 1 may vary in different embodiments, and additional components or fewer components may be used without departing from the scope of the present disclosure. Further, the functional elements illustrated in FIG. 1 may be implemented using software, hardware, firmware, or any combination thereof, and may be distributed across one or more computing systems or combined into a single computing system. Accordingly, the example embodiment illustrated in FIG. 1 is non-limiting, and other configurations consistent with the principles described herein are contemplated.

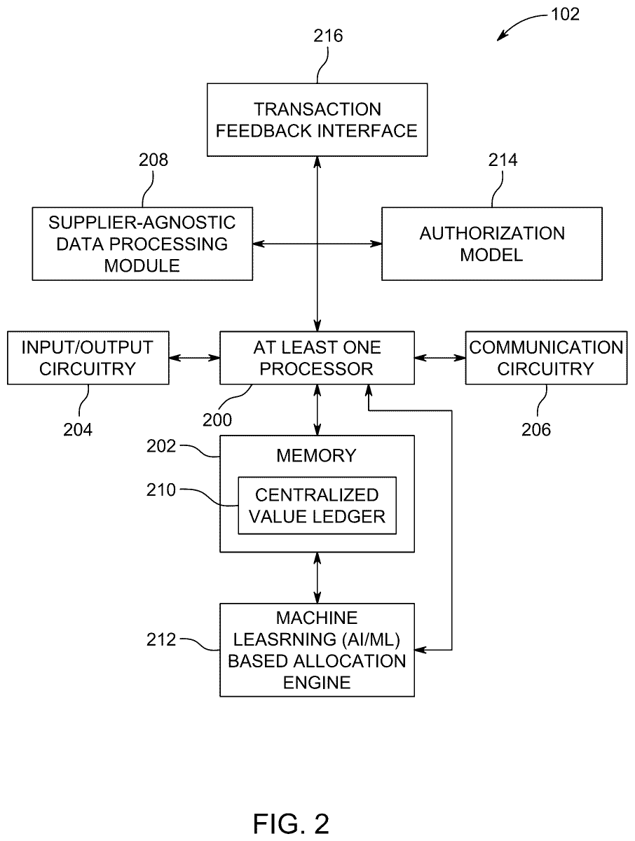

FIG. 2 illustrates a block diagram of the server 102, in accordance with an example embodiment of the present disclosure. In some embodiments, the server 102 comprises at least one processor 200, a memory 202, an input/output circuitry 204, a communication circuitry 206, a supplier-agnostic data processing module 208, a centralized value ledger 210, a machine learning (ML) based allocation engine 212, an authorization model 214, and a transactional feedback interface 216.

In some embodiments, the at least one processor 200 comprises one or more processing units configured to execute computer-readable instructions stored in the memory 202. The at least one processor 200 may include one or more general-purpose processors, special-purpose processors, or a combination thereof, and may be implemented using any suitable processing architecture. The at least one processor 200 is communicatively coupled to the memory 202, the input/output circuitry 204, and the communication circuitry 206, and is configured to coordinate operations performed by the server 102. In some embodiments, the at least one processor 200 may be implemented as a single processing device or as multiple processing devices operating in parallel or in a distributed manner.

In some embodiments, the at least one processor 200 may be configured to receive, via the one or more application programming interfaces 104, the event-driven booking data from at least one travel supplier system, the event-driven booking data being generated in response to a travel booking creation, modification, cancellation, or partial fulfilment.

In some embodiments, receiving the event-driven booking data via the one or more application programming interfaces 104 enables the at least one processor 200 to obtain booking-related information in a programmatic and event-responsive manner. The event-driven booking data is transmitted in association with specific booking lifecycle events and is received by the at least one processor 200 without requiring manual initiation or periodic data polling. Communication through the one or more application programming interfaces 104 allows the at least one processor 200 to interface with external systems using defined data exchange protocols, thereby supporting timely acquisition of booking-related information as booking events occur. By receiving the event-driven booking data in this manner, the at least one processor 200 is able to operate on current booking state information corresponding to travel booking creation, modification, cancellation, or partial fulfilment events.

In some embodiments, the at least one processor 200 may be configured to parse and normalize, using the supplier-agnostic data processing module 208, the event-driven booking data to generate the standardized unused travel value object comprising at least a monetary value, expiration data, traveller identification data, enterprise association data, and supplier-specific usage constraints.

In some embodiments, parsing the event-driven booking data includes analyzing data elements received from external systems to identify information relevant to unused travel value resulting from a booking-related event. The supplier-agnostic data processing module 208 is configured to operate independently of supplier-specific data formats, schemas, or conventions, thereby enabling the at least one processor 200 to interpret booking data originating from different travel supplier systems in a consistent manner. Normalization performed by the supplier-agnostic data processing module 208 may include transforming the parsed data elements into a standardized internal representation that is uniform across different suppliers. This standardized representation allows subsequent processing to be performed without requiring awareness of supplier-specific variations in booking data structure.

In some embodiments, the standardized unused travel value object represents a consolidated data construct that encapsulates attributes associated with unused travel value derived from a booking-related event. The monetary value included in the standardized unused travel value object corresponds to an amount associated with unused or residual travel value. Expiration data represents temporal information defining a period during which the unused travel value remains valid. Traveller identification data identifies a traveller associated with the unused travel value, and enterprise association data identifies an enterprise context applicable to the unused travel value. Supplier-specific usage constraints represent conditions imposed by a travel supplier that govern how the unused travel value may be applied.

In some embodiments, the supplier-agnostic data processing module 208 functions as a logical component implemented using software instructions executed by the at least one processor 200, alone or in combination with data stored in the memory 202. The supplier-agnostic data processing module 208 enables decoupling of internal data handling from external supplier-specific implementations, thereby supporting interoperability with multiple travel supplier systems. By generating the standardized unused travel value object through parsing and normalization, the at least one processor 200 establishes a consistent data foundation upon which further operations associated with centralized travel value management may be performed.

Further, the at least one processor 200 may be configured to store the standardized unused travel value object in the centralized value ledger 210 maintained in the memory 202. The centralized value ledger 210 is a continuously synchronized data structure configured to track a lifecycle state of each standardized unused travel value object comprising at least available, assigned, consumed, expired, or forfeited states.

In some embodiments, storing the standardized unused travel value object in the centralized value ledger 210 enables the at least one processor 200 to maintain a persistent representation of unused travel value within the server 102. The centralized value ledger 210 may be implemented using one or more data structures stored in the memory 202 and is configured to maintain an authoritative record of standardized unused travel value objects over time. By maintaining the centralized value ledger 210 within the memory 202, the server 102 is able to retain unused travel value information independently of external travel supplier systems and without reliance on transient booking transactions.

In some embodiments, the centralized value ledger 210 is continuously synchronized such that changes affecting standardized unused travel value objects are reflected in an up-to-date manner within the memory 202. Continuous synchronization allows the centralized value ledger 210 to accurately represent the current lifecycle state of each standardized unused travel value object as conditions change. Lifecycle state information associated with a standardized unused travel value object enables differentiation between unused travel value that is available for potential use, unused travel value that has been assigned, unused travel value that has been consumed during a booking workflow, unused travel value that has expired due to temporal constraints, and unused travel value that has been forfeited in accordance with applicable conditions.

In some embodiments, the centralized value ledger 210 functions as a logical construct that associates standardized unused travel value objects with corresponding lifecycle state information rather than duplicating or transferring supplier-originated credit data. The centralized value ledger 210 may retain state-related metadata, timestamps, or identifiers associated with standardized unused travel value objects to support accurate tracking of lifecycle transitions. By representing lifecycle state within the centralized value ledger 210, the at least one processor 200 is able to manage unused travel value in a structured and consistent manner without introducing dependency on supplier-specific record-keeping mechanisms.

Further, the at least one processor 200 may be configured to determine, based at least on enterprise policy rules, traveller identity data, and organizational group membership, a set of eligible candidate travellers within an enterprise for assignment of the standardized unused travel value object. In some embodiments, determining the set of eligible candidate travellers involves evaluating information associated with an enterprise context to identify travellers that satisfy predefined eligibility conditions applicable to the standardized unused travel value object. Enterprise policy rules may define constraints or criteria governing which travellers are permitted to receive unused travel value, and such rules may be stored in or accessible to the server 102. Traveller identity data may include information used to uniquely identify travellers within the enterprise, while organizational group membership may reflect associations between travellers and one or more organizational units within the enterprise. By applying these inputs, the at least one processor 200 identifies a subset of travellers that are eligible to be considered for assignment of the standardized unused travel value object.

In some embodiments, the set of eligible candidate travellers represents a filtered group of travellers that meet enterprise-defined conditions without yet performing selection or assignment of the standardized unused travel value object. Determining the set of eligible candidate travellers at this stage allows subsequent processing to be constrained to travellers that are authorized within the enterprise context, while deferring any optimization or selection logic to later processing. This separation enables eligibility determination to be performed independently of allocation decisions and supports consistent enforcement of enterprise policy rules across different standardized unused travel value objects.

Further, the at least one processor 200 may be configured to execute, using the machine-learning based allocation engine 212, the allocation determination process configured to automatically rank and select, from the set of eligible candidate travellers, a candidate traveller for assignment of the standardized unused travel value object based on predicted utilization and expiration avoidance.

In some embodiments, the machine-learning based allocation engine 212 is configured to operate on the set of eligible candidate travellers previously determined by the at least one processor 200. The machine-learning based allocation engine 212 may evaluate predictive information associated with the standardized unused travel value object and the eligible candidate travellers to assess relative suitability for assignment. Predicted utilization reflects an estimated likelihood that a standardized unused travel value object will be applied by a given eligible candidate traveller within a remaining validity period, while expiration avoidance reflects an assessment of whether assignment to a given eligible candidate traveller is likely to prevent the standardized unused travel value object from expiring unused. By performing such predictive evaluation, the machine-learning based allocation engine 212 enables comparative ranking of eligible candidate travellers without altering eligibility constraints defined by enterprise policy rules.

In some embodiments, the allocation determination process performed by the machine-learning based allocation engine 212 produces a ranked ordering of eligible candidate travellers based on predicted utilization and expiration-related considerations. The at least one processor 200 may select a candidate traveller for assignment from the ranked ordering generated by the allocation determination process. The ranking and selection performed by the machine-learning based allocation engine 212 are distinct from eligibility determination and are directed toward optimizing assignment outcomes within the enterprise context, while remaining constrained to the set of eligible candidate travellers previously identified.

Further, the at least one processor 200 may be configured to assign the standardized unused travel value object to the selected candidate traveller by updating the centralized value ledger 210 without exposing supplier-originated credit identifiers or redemption credentials to the selected candidate traveller, thereby enforcing enterprise-only usage and preventing unauthorized external transfer. In some embodiments, assigning the standardized unused travel value object includes establishing an association between the standardized unused travel value object and the selected candidate traveller within the centralized value ledger 210. Updating the centralized value ledger 210 in this manner enables the at least one processor 200 to reflect assignment as a change in state or relationship recorded in the memory 202, rather than through transfer or disclosure of underlying supplier-originated credit data. The centralized value ledger 210 thereby serves as a control mechanism through which assignment is enforced at the system level while preserving the integrity of supplier-originated information.

In some embodiments, preventing exposure of supplier-originated credit identifiers or redemption credentials ensures that the selected candidate traveller does not obtain direct access to data that could be reused, shared, or applied outside authorized enterprise workflows. By retaining such identifiers or credentials solely within the server 102 and representing assignment through ledger-based associations, the at least one processor 200 enforces enterprise-only usage of the standardized unused travel value object. This approach further prevents unauthorized external transfer by ensuring that use of the standardized unused travel value object remains subject to system-controlled validation and subsequent processing, rather than traveller-controlled handling of credit information.

Further, the at least one processor 200 may be configured to determine, in real time and prior to a checkout transaction, traveller eligibility for use of the assigned standardized unused travel value object by applying the authorization model 214 that evaluates traveller identity data, enterprise policy rules, booking channel attributes, and the supplier-specific usage constraints associated with the standardized unused travel value object. In some embodiments, the authorization model 214 functions as a runtime enforcement mechanism that determines whether the assigned standardized unused travel value object may be used under current booking conditions. The authorization model 214 may be implemented as a logical construct executed by the at least one processor 200 and is applied after assignment of the standardized unused travel value object and prior to its use during a checkout transaction. By performing authorization in real time, the at least one processor 200 ensures that eligibility for use is evaluated based on current traveller attributes, enterprise conditions, and booking context, rather than solely on information available at the time of assignment.

In some embodiments, traveller identity data evaluated by the authorization model 214 is used to confirm that the traveller attempting to use the standardized unused travel value object corresponds to the selected candidate traveller to whom the unused travel value object was assigned. Enterprise policy rules evaluated by the authorization model 214 may define conditions under which assigned unused travel value is permitted or restricted within an enterprise context. Booking channel attributes may indicate whether the checkout transaction is occurring through an enterprise-approved booking channel, and supplier-specific usage constraints may define limitations imposed by a travel supplier on how or when the standardized unused travel value object may be applied. By collectively evaluating these inputs, the authorization model 214 enables the at least one processor 200 to permit or restrict use of the standardized unused travel value object in a controlled and policy-compliant manner.

Further, the at least one processor 200 may be configured to transmit, upon determining traveller eligibility, the assigned standardized unused travel value object to a checkout system (not shown) of the at least one travel supplier system during a booking workflow such that the standardized unused travel value object is automatically surfaced and applied during checkout without requiring manual credit entry by the traveller.

In some embodiments, transmitting the assigned standardized unused travel value object enables the at least one processor 200 to make the unused travel value available to a checkout system associated with a travel supplier system during an active booking workflow. Such transmission may occur after successful evaluation by the authorization model 214 and may be performed through programmatic communication mechanisms supported by the communication circuitry 206. By transmitting information corresponding to the standardized unused travel value object in this manner, the at least one processor 200 allows the checkout system to recognize the availability of unused travel value for the booking transaction without requiring the traveller to manually provide credit identifiers, codes, or redemption credentials.

In some embodiments, automatic surfacing and application of the standardized unused travel value object during checkout allows unused travel value to be incorporated into the booking transaction in a seamless manner that is controlled by the server 102. The standardized unused travel value object may be applied in accordance with supplier-defined checkout behavior while remaining subject to enterprise policy rules and supplier-specific usage constraints previously evaluated by the authorization model 214. By eliminating manual credit entry by the traveller, the at least one processor 200 reduces reliance on traveller-managed information and supports consistent, policy-compliant use of unused travel value within enterprise booking workflows.

Further, the at least one processor 200 may be configured to detect, via the transactional feedback interface 216, consumption of the standardized unused travel value object during completion of the booking workflow. In some embodiments, detecting consumption of the standardized unused travel value object involves receiving feedback data indicative of completion of a booking transaction in which the unused travel value has been applied. The transactional feedback interface 216 may be configured to receive such feedback data from a checkout system or a travel supplier system upon completion of a booking workflow. Detection of consumption enables the at least one processor 200 to determine that the standardized unused travel value object has been used in association with a booking transaction, rather than remaining available or assigned.

In some embodiments, the transactional feedback interface 216 functions as a communication mechanism through which the server 102 is informed of transaction outcomes related to standardized unused travel value objects. Feedback received via the transactional feedback interface 216 may indicate successful application of the unused travel value during checkout or confirmation that the booking workflow has been completed. By detecting consumption through the transactional feedback interface 216, the at least one processor 200 is able to identify completion of use of the standardized unused travel value object in a reliable and system-controlled manner, without requiring manual confirmation or external reconciliation.

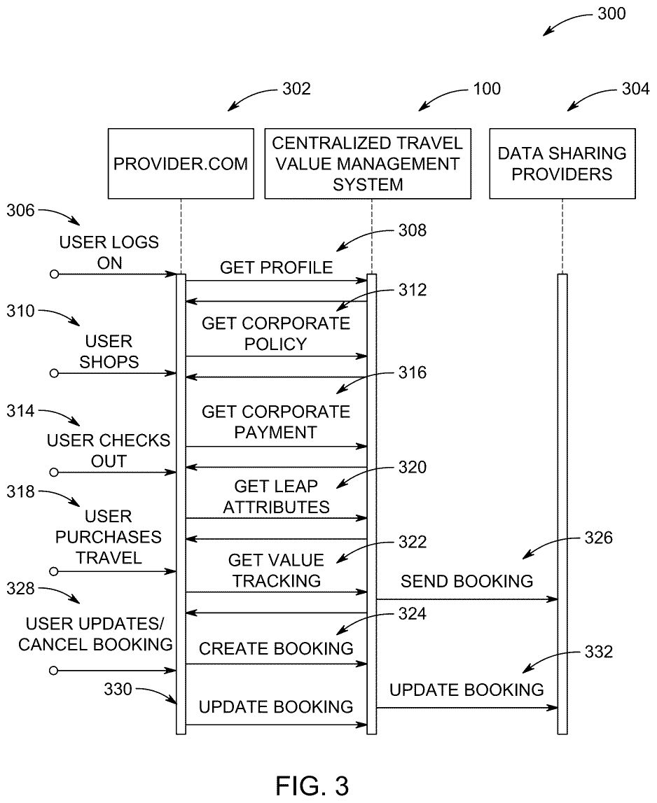

FIG. 3 illustrates an example interaction flow 300 between multiple systems involved in an enterprise travel booking lifecycle, in accordance with an example embodiment of the present disclosure. As shown, the interaction flow 300 includes an external booking platform (provider. com) 302, a centralized travel value management system 100, and one or more data sharing providers 304. The interaction flow 300 represents an example sequence of communications that may occur during travel booking creation, booking updates, and unused travel value tracking within an enterprise travel environment.

In the illustrated embodiment, the external booking platform 302 (labeled “provider.com” in FIG. 3) represents a travel supplier booking interface through which a traveller interacts to perform booking-related actions, such as logging in, searching for travel options, checking out, purchasing travel, or modifying an existing booking. The external booking platform 302 may be operated by an airline, travel supplier, or enterprise booking portal. The centralized travel value management system 100 operates as a centralized system configured to interface with the external booking platform 302 and the one or more data sharing provider systems 304. The centralized travel value management system 100 facilitates retrieval and exchange of enterprise-related information, booking-related data, and unused travel value information during the booking lifecycle.

The one or more data sharing providers 304 (labeled “Data Sharing Providers” in FIG. 3) represent external systems that receive booking-related information from the centralized travel value management system 100. Such data sharing provider systems 304 may support downstream processing, reporting, reconciliation, analytics, or other post-booking operations associated with completed or updated travel bookings. In a real-life example, a traveller employed by an enterprise may access the external booking platform 302 to initiate a business travel booking. When the traveller logs on to the external booking platform 302, the external booking platform 302 may transmit a request to the centralized travel value management system 100 to obtain traveller profile information. The centralized travel value management system 100 may return profile-related data that allows the external booking platform 302 to identify the traveller within an enterprise context.

As the traveller shops for travel options, the external booking platform 302 may request enterprise policy information from the centralized travel value management system 100. In response, the centralized travel value management system 100 may provide enterprise policy data that governs permissible booking options, payment methods, or booking conditions applicable to the traveller. When the traveller proceeds to check out on the external booking platform 302, the external booking platform 302 may request enterprise payment information or information relating to available unused travel value. The centralized travel value management system 100 may respond by providing information that enables the external booking platform 302 to account for enterprise payment mechanisms or unused travel value during the checkout process.

After the traveller completes a booking, the external booking platform 302 may transmit booking information to the centralized travel value management system 100, indicating that a travel booking has been created. The centralized travel value management system 100 may further transmit booking-related information to the one or more data sharing provider systems 304 to support downstream processing or synchronization. If the traveller later updates or cancels the booking using the external booking platform 302, updated booking information may again be transmitted to the centralized travel value management system 100. Such updated booking information may indicate that unused travel value has been generated as a result of the booking modification or cancellation. The centralized travel value management system 100 may process the updated booking information to enable tracking of unused travel value associated with the booking. The centralized travel value management system 100 may also transmit updated booking or value-related information to the one or more data sharing provider systems 304 to ensure that booking status and value information remain consistent across participating systems.

At operation 306 (User Logs On), a traveller initiates access to the external booking platform 302, for example by logging in to an enterprise travel booking website. At operation 308 (Get Profile), the external booking platform 302 transmits a request to the centralized travel value management system 100 to obtain traveller profile information associated with the logged-in traveller. The centralized travel value management system 100 responds with profile-related data that enables identification of the traveller within an enterprise context. At operation 310 (User Shops), the traveller searches for available travel options using the external booking platform 302.

At operation 312 (Get Corporate Policy), the external booking platform 302 requests enterprise policy information from the centralized travel value management system 100. Such policy information may govern permissible booking options, fare classes, or booking conditions applicable to the traveller. At operation 314 (User Checks Out), the traveller proceeds toward checkout after selecting travel options. At operation 316 (Get Corporate Payment), the external booking platform 302 requests enterprise payment-related information from the centralized travel value management system 100. The centralized travel value management system 100 provides information enabling the booking to be processed in accordance with enterprise payment arrangements. At operation 318 (User Purchases Travel), the traveller completes the booking transaction using the external booking platform 302.

At operation 320 (Get LEAP Attributes), the external booking platform 302 retrieves additional enterprise-related attributes from the centralized travel value management system 100 that may be associated with the completed booking. At operation 322 (Get Value Tracking), the external booking platform 302 requests information from the centralized travel value management system 100 regarding unused travel value or value-tracking data associated with the booking. At operation 324 (Create Booking), the external booking platform 302 transmits booking creation information to the centralized travel value management system 100. At operation 326 (Send Booking), the centralized travel value management system 100 transmits booking information to the one or more data sharing provider systems 304 to support downstream processing, reporting, or synchronization.

At operation 328 (User Updates/Cancel Booking), the traveller modifies or cancels a previously created booking using the external booking platform 302. At operation 330 (Update Booking), the external booking platform 302 transmits updated booking information to the centralized travel value management system 100, indicating changes that may result in unused or residual travel value. At operation 332 (Update Booking), the centralized travel value management system 100 transmits updated booking or value-related information to the one or more data sharing provider systems 304 to maintain consistency across systems.

The interaction flow 300 illustrated in FIG. 3 demonstrates how user-initiated actions and system-initiated exchanges are coordinated across the external booking platform 302, the centralized travel value management system 100, and the data sharing provider systems 304 during an enterprise travel booking lifecycle. The illustrated operations enable retrieval of profile information, enterprise policy enforcement, payment handling, booking creation, booking updates, and tracking of unused travel value in a coordinated manner.

It should be understood that the interaction flow 300 illustrated in FIG. 3 is provided for purposes of illustration only and is not intended to limit the scope of the present disclosure. The number, order, and direction of interactions between the external booking platform 302, the centralized travel value management system 100, and the one or more data sharing provider systems 304 may vary in different embodiments. Additional systems may participate in the interaction flow 300, or certain interactions may be omitted, without departing from the scope of the present disclosure.

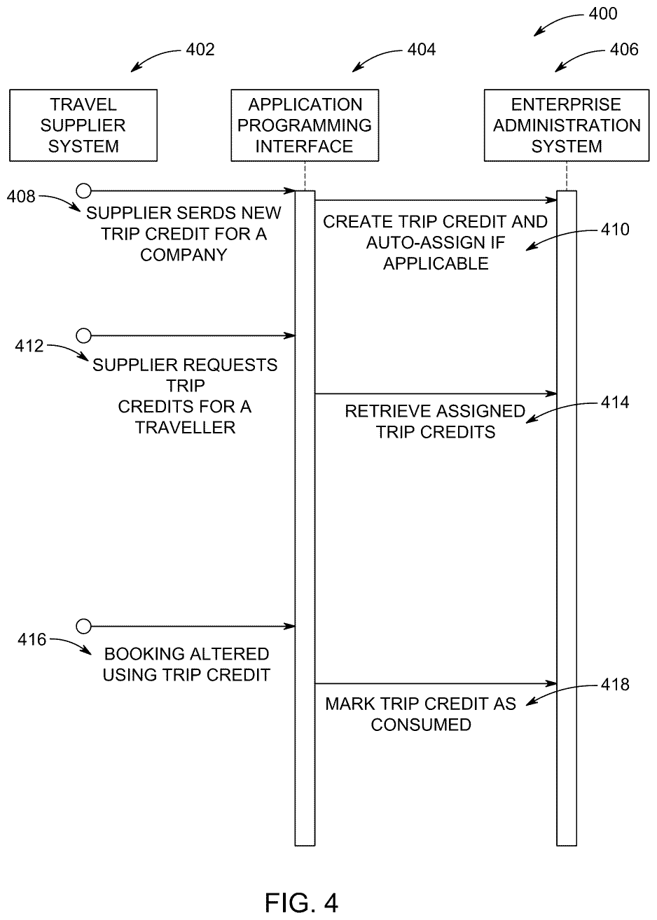

FIG. 4 illustrates an example value-tracking interaction flow 400 associated with management of standardized unused travel value objects within an enterprise travel environment, in accordance with an example embodiment of the present disclosure. As shown, the interaction flow 400 involves a travel supplier system 402, one or more application programming interfaces 404, and an enterprise administration system 406 operating in communication with the centralized travel value management system 100.

At operation 408 (Supplier Sends New Trip Credit for a Company), the travel supplier system 402 transmits information corresponding to a newly generated trip credit or unused travel value to the centralized travel value management system 100 via the one or more application programming interfaces 404. Such trip credit may be generated as a result of a booking cancellation, modification, or other booking-related event.

At operation 410 (Create Trip Credit and Auto-Assign if Applicable), the centralized travel value management system 100 processes the received information to create a standardized unused travel value object and stores the standardized unused travel value object in the centralized value ledger. In some embodiments, the centralized travel value management system 100 may automatically associate the standardized unused travel value object with a traveller within the enterprise based on applicable enterprise policy rules and eligibility criteria.

At operation 412 (Supplier Requests Trip Credits for a Traveller), the travel supplier system 402 invokes the one or more application programming interfaces 404 to request information regarding available credit cards or standardized unused travel value objects associated with a specified traveller.

At operation 414 (Retrieve Assigned Trip Credits), the enterprise administration system 406 queries the centralized travel value management system 100 to identify any standardized unused travel value objects assigned to the requested traveller. The centralized travel value management system 100 retrieves assignment and lifecycle state information from the centralized value ledger and returns corresponding information indicating which standardized unused travel value objects are available for use.

At operation 416 (Booking Altered Using Trip Credit), a booking is completed or modified using a standardized unused travel value object, and the travel supplier system 402 transmits a request via the one or more application programming interfaces 404 indicating that the standardized unused travel value object has been applied during a booking workflow. At operation 418 (Mark Trip Credit as Consumed), the centralized travel value management system 100 updates the centralized value ledger to reflect that the standardized unused travel value object has transitioned to a consumed lifecycle state. The enterprise administration system 406 may access updated lifecycle state information to maintain an accurate view of unused travel value usage within the enterprise.

The interaction flow 400 illustrated in FIG. 4 demonstrates how standardized unused travel value objects may be created, queried, assigned, and marked as consumed through coordinated interactions between the travel supplier system 402, the application programming interfaces 404, and the enterprise administration system 406. By managing creation, assignment, retrieval, and consumption status centrally, the centralized travel value management system 100 enables consistent tracking and controlled use of unused travel value across enterprise travel workflows.

It should be understood that the interaction flow 400 illustrated in FIG. 4 is provided for purposes of illustration only and is not intended to limit the scope of the present disclosure. The number, order, or arrangement of the operations 408-418 may vary in different embodiments, and additional operations may be included or certain operations may be omitted without departing from the scope of the present disclosure.

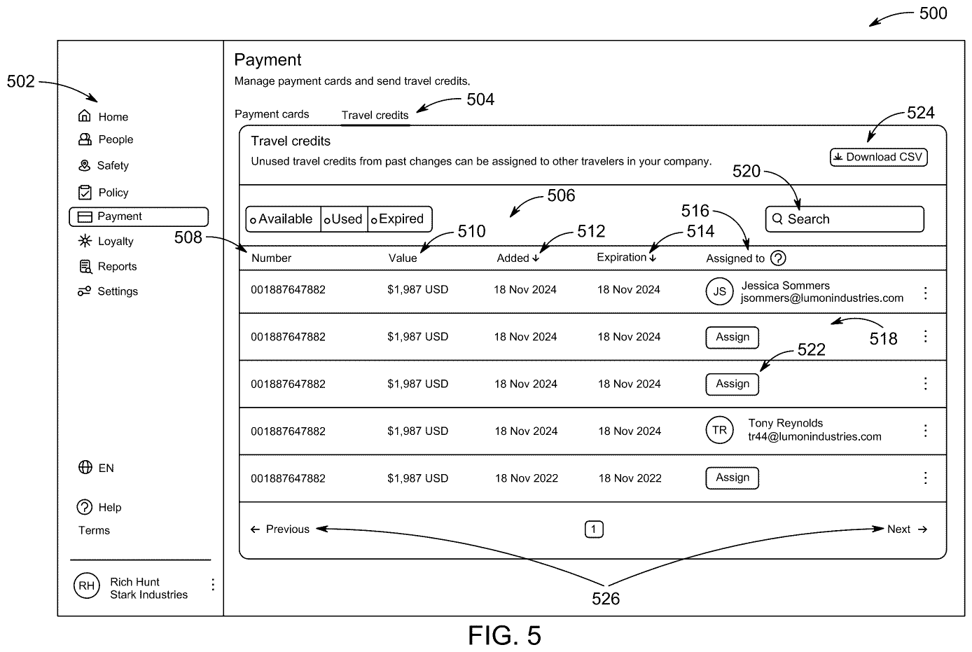

FIG. 5 illustrates an example administrative user interface 500 for managing standardized unused travel value objects within an enterprise travel environment, in accordance with an example embodiment of the present disclosure.

The administrative user interface 500 may be presented by the centralized travel value management system 100 to an authorized enterprise administrator or travel manager and is provided to illustrate one possible visual representation of unused travel value information. As shown in FIG. 5, the administrative user interface 500 includes a navigation region 502 that provides access to multiple enterprise management functions, including payment management, policy configuration, reporting, and settings. Selection of a payment management option within the navigation region 502 may cause display of a travel credits view 504 corresponding to standardized unused travel value objects maintained by the centralized travel value management system 100.

The travel credits view 504 displays a listing region 506 that presents multiple standardized unused travel value objects associated with an enterprise. Each standardized unused travel value object may be represented as a row within the listing region 506 and may include corresponding attribute fields such as a reference identifier 508, a monetary value 510, an added date 512, an expiration date 514, and an assignment status 516.

In some embodiments, the listing region 506 may further present standardized unused travel value objects according to one or more lifecycle states maintained by the centralized travel value management system 100. Such lifecycle states may include available, used, or expired states, and may be selectively displayed through one or more state selection controls 518. The state selection controls 518 enable an authorized user to filter the standardized unused travel value objects displayed within the listing region 506 based on current lifecycle state.

In some embodiments, the administrative user interface 500 may include a search input control 520 that enables filtering of standardized unused travel value objects based on entered search criteria. The search criteria may correspond to one or more attribute fields associated with the standardized unused travel value objects, such as reference identifiers, assignee identifiers, or date-related attributes, thereby allowing an authorized user to efficiently locate specific unused travel value objects maintained by the centralized travel value management system 100.

For standardized unused travel value objects that are not yet assigned, the listing region 506 may present an assignment control 522. Selection of the assignment control 522 may initiate an assignment operation through which the standardized unused travel value object is associated with a selected candidate traveller in accordance with enterprise policy rules and eligibility criteria enforced by the centralized travel value management system 100. In some embodiments, assignment initiated through the administrative user interface 500 results in an update to the centralized value ledger without exposing supplier-originated credit identifiers or redemption credentials.

For standardized unused travel value objects that are already assigned, the assignment status 516 may indicate an identity associated with the assigned traveller. Such identification may be presented in a limited form sufficient for administrative oversight while maintaining enterprise-controlled handling of the standardized unused travel value object and preventing unauthorized external transfer or misuse. In some embodiments, the administrative user interface 500 may further include a data export control 524 that enables an authorized user to obtain a structured data representation of standardized unused travel value objects displayed within the listing region 506. The exported data may reflect information maintained within the centralized value ledger at the time of export.

The administrative user interface 500 may additionally include pagination controls 526 that enable navigation through multiple pages of standardized unused travel value objects when the number of entries exceeds a display threshold. Pagination operations may be performed without altering the underlying lifecycle state or assignment status of the standardized unused travel value objects.

It should be understood that the administrative user interface 500 illustrated in FIG. 5 is provided for purposes of illustration only and is not intended to limit the scope of the present disclosure. The arrangement, appearance, and functionality of the interface elements shown in FIG. 5 may vary in different embodiments, and additional or fewer interface elements may be provided without departing from the scope of the present disclosure.

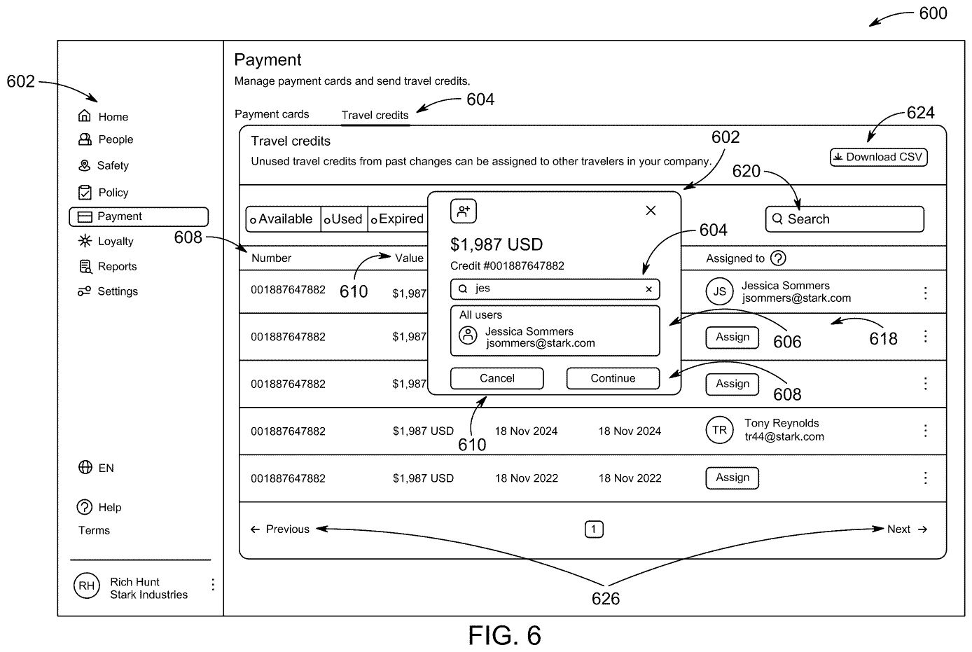

FIG. 6 illustrates an example assignment interface 600 presented within the administrative user interface 500, in accordance with an example embodiment of the present disclosure.

The assignment interface 600 is shown as an overlay relative to the travel credits view described with reference to FIG. 5 and is presented to facilitate assignment of a standardized unused travel value object to a traveller associated with an enterprise. As shown in FIG. 6, the assignment interface 600 includes a value summary region 602 that displays information associated with as elected standardized unused travel value object. The value summary region 602 includes a monetary value and an internal credit reference identifier corresponding to the standardized unused travel value object. The information displayed within the value summary region 602 is presented without exposing supplier-originated credit identifiers or redemption credentials.

The assignment dialog 600 further includes a traveller search field 604 configured to receive input for identifying a traveller within the enterprise. The traveller search field 604 enables filtering of travellers associated with the enterprise based on entered text. In the illustrated embodiment, a filtered traveller list 606 is displayed below the traveller search field 604 and presents one or more traveller entries that match the entered input. Each traveller entry displayed within the filtered traveller list 606 may include identifying information sufficient to distinguish between travellers associated with the enterprise. The travellers presented within the filtered traveller list 606 correspond to travellers eligible for assignment of the standardized unused travel value object in accordance with enterprise policy rules enforced by the centralized travel value management system 100.

The assignment dialog 600 further includes action controls comprising a continue control 608 and a cancellation control 610. Selection of the continue control 608 causes the centralized travel value management system 100 to proceed with assignment of the standardized unused travel value object to a selected candidate traveller by updating the centralized value ledger, while selection of the cancellation control 610 dismisses the assignment dialog 600 without modifying assignment state.

It should be understood that the assignment dialog 600 illustrated in FIG. 6 is provided for purposes of illustration only and is not intended to limit the scope of the present disclosure. The layout, presentation, and arrangement of interface elements shown in FIG. 6 may vary in different embodiments without departing from the scope of the present disclosure.

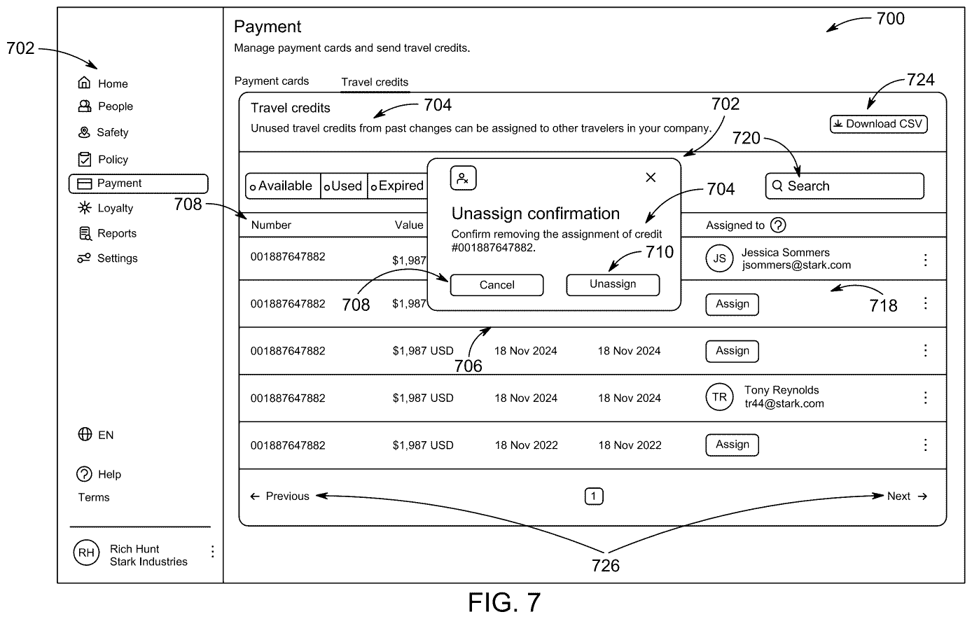

FIG. 7 illustrates an example unassignment confirmation dialog 700 displayed within the administrative user interface 500, in accordance with an example embodiment of the present disclosure.

The unassignment confirmation dialog 700 is shown as an overlay relative to the travel credits view described with reference to FIG. 5 and is presented to confirm removal of an assignment associated with a standardized unused travel value object. As shown in FIG. 7, the unassignment confirmation dialog 700 includes a dialog header region 702 indicating that the interface relates to confirmation of an unassignment operation. The dialog header region 702 visually distinguishes the unassignment confirmation dialog 700 from other interface elements presented within the administrative user interface 500.

The unassignment confirmation dialog 700 further includes a value reference region 704 that displays an internal reference identifier associated with the standardized unused travel value object for which assignment removal is being confirmed. The value reference region 704 provides identification of the standardized unused travel value object without exposing supplier-originated credit identifiers or redemption credentials. The unassignment confirmation dialog 700 also includes action controls 706 comprising a cancellation control 708 and an unassignment confirmation control 710. Selection of the cancellation control 708 dismisses the unassignment confirmation dialog 700 without modifying assignment state. Selection of the unassignment confirmation control 710 causes the centralized travel value management system 100 to remove the association between the standardized unused travel value object and a previously assigned traveller by updating the centralized value ledger.

In some embodiments, removal of the assignment results in the standardized unused travel value object transitioning from an assigned lifecycle state to an available lifecycle state within the centralized value ledger, thereby making the standardized unused travel value object eligible for reassignment in accordance with enterprise policy rules.

It should be understood that the unassignment confirmation dialog 700 illustrated in FIG. 7 is provided for purposes of illustration only and is not intended to limit the scope of the present disclosure. The layout, wording, and arrangement of interface elements shown in FIG. 7 may vary in different embodiments without departing from the scope of the present disclosure.

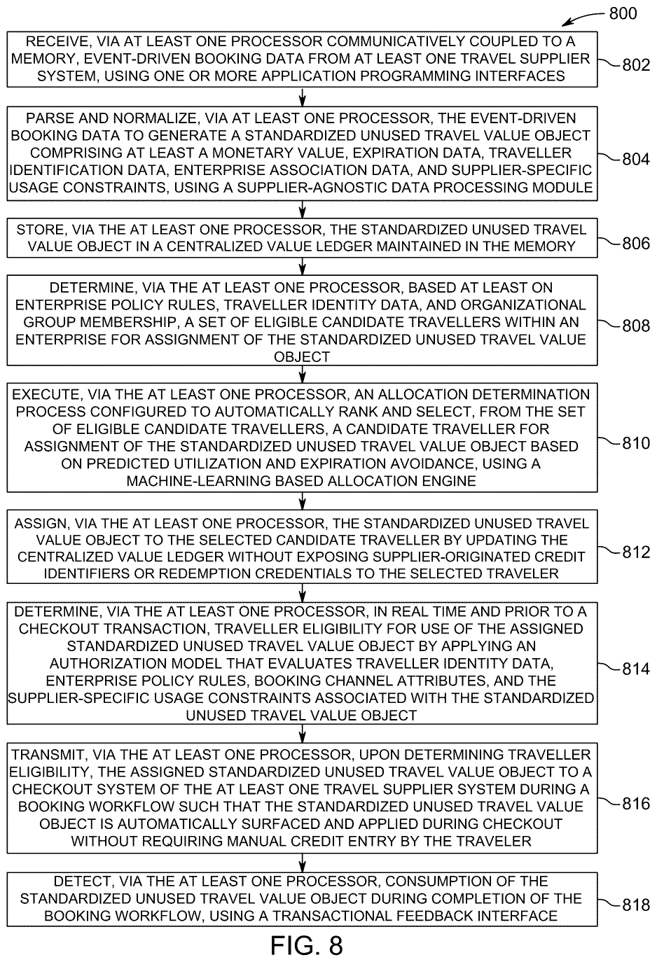

FIG. 8 illustrates a flowchart showing a method 800 for centralized travel value management, in accordance with an example embodiment of the present disclosure.

At operation 802, the at least one processor 200 receives, via the one or more application programming interfaces 104, the event-driven booking data from at least one travel supplier system, the event-driven booking data being generated in response to a travel booking creation, modification, cancellation, or partial fulfilment.

At operation 804, the at least one processor 200 parses and normalizes, using the supplier-agnostic data processing module 208, the event-driven booking data to generate the standardized unused travel value object comprising at least a monetary value, expiration data, traveller identification data, enterprise association data, and supplier-specific usage constraints.

At operation 806, the at least one processor 200 stores the standardized unused travel value object in the centralized value ledger 210 maintained in the memory 202

At operation 808, the at least one processor 200 determines, based at least on enterprise policy rules, traveller identity data, and organizational group membership, a set of eligible candidate travellers within an enterprise for assignment of the standardized unused travel value object. In some embodiments, determining the set of eligible candidate travellers comprises excluding travellers outside the enterprise associated with the standardized unused travel value object. In some embodiments, determining the set of eligible candidate travellers is based further on at least one of traveller employment status, organizational unit, department code, cost center, or enterprise policy tier. In some embodiments, the set of eligible candidate travellers is dynamically updated in response to changes in enterprise policy rules or traveller status data.

At operation 810, the at least one processor 200 executes, using the machine-learning based allocation engine 212, the allocation determination process configured to automatically rank and select, from the set of eligible candidate travellers, a candidate traveller for assignment of the standardized unused travel value object based on predicted utilization and expiration avoidance. In some embodiments, the machine-learning based allocation engine 212 is trained using historical unused travel value consumption data, expiration data, and traveller booking behaviour data.

At operation 812, the at least one processor 200 assigns the standardized unused travel value object to the selected candidate traveller by updating the centralized value ledger 210 without exposing supplier-originated credit identifiers or redemption credentials to the selected candidate traveller, thereby enforcing enterprise-only usage and preventing unauthorized external transfer. In some embodiments, assigning the standardized unused travel value object causes the centralized value ledger to update the lifecycle state from available to assigned. In some embodiments, assigning the standardized unused travel value object comprises locking the standardized unused travel value object to a single selected candidate traveller to prevent concurrent redemption. In some embodiments, the standardized unused travel value object is associated with an internal token that replaces supplier-originated credit identifiers during storage and transmission. In some embodiments, application of the standardized unused travel value object during checkout is designated as mandatory or optional based on enterprise policy rules.

At operation 814, the at least one processor 200 determines, in real time and prior to a checkout transaction, traveller eligibility for use of the assigned standardized unused travel value object by applying the authorization model 214 that evaluates traveller identity data, enterprise policy rules, booking channel attributes, and the supplier-specific usage constraints associated with the standardized unused travel value object

At operation 816, the at least one processor 200 transmits, upon determining traveller eligibility, the assigned standardized unused travel value object to the checkout system (not shown) of the at least one travel supplier system during a booking workflow such that the standardized unused travel value object is automatically surfaced and applied during checkout without requiring manual credit entry by the traveller.

At operation 818, the at least one processor 200 detects, via the transactional feedback interface 216, consumption of the standardized unused travel value object during completion of the booking workflow. In some embodiments, detecting consumption causes the centralized value ledger to update the lifecycle state to consumed. In some embodiments, the updated lifecycle state is propagated in real time to an enterprise administration system and the at least one travel supplier system to maintain synchronized credit state consistency across distributed computing environments. In some embodiments, real-time propagation of lifecycle state changes reduces data inconsistency across distributed computing systems associated with the enterprise and the at least one travel supplier system. In some embodiments, the centralized value ledger operates as a single source of truth for standardized unused travel value objects across a plurality of travel supplier systems.

The present disclosure provides several technical and operational advantages over conventional travel booking and credit management systems. In particular, the centralized travel value management system enables automated, policy-compliant tracking, assignment, and application of unused travel value across distributed travel supplier systems without requiring manual intervention by travellers or administrators. By maintaining standardized unused travel value objects within a centralized value ledger that operates as a continuously synchronized single source of truth, the system reduces data inconsistency, credit loss due to expiration, and fragmented recordkeeping across enterprise and supplier platforms. Further, the integration of machine-learning based allocation and real-time authorization models improves computer functionality by enabling dynamic, data-driven decision-making that adapts to changing enterprise policies, traveller behavior, and booking contexts. The disclosed architecture eliminates reliance on static rules and manual credit sharing mechanisms, while preventing unauthorized external transfer through secure ledger-based assignment that avoids exposure of supplier-originated credit identifiers. Additionally, automatic surfacing and application of unused travel value during checkout reduces transaction friction, minimizes user error, and improves utilization efficiency of enterprise travel resources. Collectively, these features improve system scalability, security, and operational efficiency in managing unused travel value across complex, multi-system enterprise travel environments.

Many modifications and other embodiments of the disclosure set forth herein will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A centralized travel value management system, comprising:
a memory configured to store one or more instructions; and
at least one processor communicatively coupled to the memory, wherein the at least one processor, when executing the one or more instructions, is configured to:
receive, via one or more application programming interfaces, event-driven booking data from at least one travel supplier system, the event-driven booking data being generated in response to a travel booking creation, modification, cancellation, or partial fulfilment;
parse and normalize, using a supplier-agnostic data processing module, the event-driven booking data to generate a standardized unused travel value object comprising at least a monetary value, expiration data, traveller identification data, enterprise association data, and supplier-specific usage constraints;
store the standardized unused travel value object in a centralized value ledger maintained in the memory, wherein the centralized value ledger is a continuously synchronized data structure configured to track a lifecycle state of each standardized unused travel value object comprising at least available, assigned, consumed, expired, or forfeited states;
determine, based at least on enterprise policy rules, traveller identity data, and organizational group membership, a set of eligible candidate travellers within an enterprise for assignment of the standardized unused travel value object;
execute, using a machine-learning based allocation engine, an allocation determination process configured to automatically rank and select, from the set of eligible candidate travellers, a candidate traveller for assignment of the standardized unused travel value object based on predicted utilization and expiration avoidance;
assign the standardized unused travel value object to the selected candidate traveller by updating the centralized value ledger without exposing supplier-originated credit identifiers or redemption credentials to the selected candidate traveller, thereby enforcing enterprise-only usage and preventing unauthorized external transfer;
determine, in real time and prior to a checkout transaction, traveller eligibility for use of the assigned standardized unused travel value object by applying an authorization model that evaluates traveller identity data, enterprise policy rules, booking channel attributes, and the supplier-specific usage constraints associated with the standardized unused travel value object; and
transmit, upon determining traveller eligibility, the assigned standardized unused travel value object to a checkout system of the at least one travel supplier system during a booking workflow such that the standardized unused travel value object is automatically surfaced and applied during checkout without requiring manual credit entry by the traveller.

2. The centralized travel value management system of claim 1, wherein the machine-learning based allocation engine is trained using historical unused travel value consumption data, expiration data, and traveller booking behaviour data.

3. The centralized travel value management system of claim 1, wherein determining the set of eligible candidate travellers comprises excluding travellers outside the enterprise associated with the standardized unused travel value object.

4. The centralized travel value management system of claim 1, wherein determining the set of eligible candidate travellers is further based on at least one of traveller employment status, organizational unit, department code, cost center, or enterprise policy tier.

5. The centralized travel value management system of claim 1, wherein the set of eligible candidate travellers is dynamically updated in response to changes in enterprise policy rules or traveller status data.

6. The centralized travel value management system of claim 1, wherein assigning the standardized unused travel value object causes the centralized value ledger to update the lifecycle state from available to assigned.

7. The centralized travel value management system of claim 1, wherein assigning the standardized unused travel value object comprises locking the standardized unused travel value object to a single selected candidate traveller to prevent concurrent redemption.

8. The centralized travel value management system of claim 1, wherein the standardized unused travel value object is associated with an internal token that replaces supplier-originated credit identifiers during storage and transmission.

9. The centralized travel value management system of claim 1, wherein application of the standardized unused travel value object during checkout is designated as mandatory or optional based on enterprise policy rules.

10. The centralized travel value management system of claim 1, wherein the least one processor, when executing the one or more instructions, is further configured to detect, via a transactional feedback interface, consumption of the standardized unused travel value object during completion of the booking workflow.

11. The centralized travel value management system of claim 10, wherein detecting consumption causes the centralized value ledger to update the lifecycle state to consumed.

12. The centralized travel value management system of claim 11, wherein the updated lifecycle state is propagated in real time to an enterprise administration system and the at least one travel supplier system to maintain synchronized credit state consistency across distributed computing environments.

13. The centralized travel value management system of claim 12, wherein real-time propagation of lifecycle state changes reduces data inconsistency across distributed computing systems associated with the enterprise and the at least one travel supplier system.

14. The centralized travel value management system of claim 1, wherein the centralized value ledger operates as a single source of truth for standardized unused travel value object across a plurality of travel supplier systems.

15. A method for centralized travel value management, comprising:
receiving, via at least one processor communicatively coupled to a memory, event-driven booking data from at least one travel supplier system, using one or more application programming interfaces, the event-driven booking data being generated in response to a travel booking creation, modification, cancellation, or partial fulfilment;
parsing and normalizing, via the at least one processor, the event-driven booking data to generate a standardized unused travel value object comprising at least a monetary value, expiration data, traveller identification data, enterprise association data, and supplier-specific usage constraints, using a supplier-agnostic data processing module;
storing, via the at least one processor, the standardized unused travel value object in a centralized value ledger maintained in the memory, wherein the centralized value ledger is a continuously synchronized data structure configured to track a lifecycle state of each standardized unused travel value object comprising at least available, assigned, consumed, expired, or forfeited states;
determining, via the at least one processor, based at least on enterprise policy rules, traveller identity data, and organizational group membership, a set of eligible candidate travellers within an enterprise for assignment of the standardized unused travel value object;
executing, via the at least one processor, an allocation determination process configured to automatically rank and select, from the set of eligible candidate travellers, a candidate traveller for assignment of the standardized unused travel value object based on predicted utilization and expiration avoidance, using a machine-learning based allocation engine;
assigning, via the at least one processor, the standardized unused travel value object to the selected candidate traveller by updating the centralized value ledger without exposing supplier-originated credit identifiers or redemption credentials to the selected candidate traveller, thereby enforcing enterprise-only usage and preventing unauthorized external transfer;
determining, via the at least one processor, in real time and prior to a checkout transaction, traveller eligibility for use of the assigned standardized unused travel value object by applying an authorization model that evaluates traveller identity data, enterprise policy rules, booking channel attributes, and the supplier-specific usage constraints associated with the standardized unused travel value object; and
transmitting, via the at least one processor, upon determining traveller eligibility, the assigned standardized unused travel value object to a checkout system of the at least one travel supplier system during a booking workflow such that the standardized unused travel value object is automatically surfaced and applied during checkout without requiring manual credit entry by the traveller.

16. The method of claim 15, wherein the machine-learning based allocation engine is trained using historical unused travel value consumption data, expiration data, and traveller booking behaviour data.

17. The method of claim 15, wherein determining the set of eligible candidate travellers comprises excluding travellers outside the enterprise associated with the standardized unused travel value object.

18. The method of claim 15, wherein determining the set of eligible candidate travellers is based further on at least one of traveller employment status, organizational unit, department code, cost center, or enterprise policy tier.

19. The method of claim 15, wherein the set of eligible candidate travellers is dynamically updated in response to changes in enterprise policy rules or traveller status data.

20. A computer program system, comprising a non-transitory computer usable medium having a computer readable program code therein, the computer readable program code adapted to be executed for centralized travel value management, the method comprising:
receiving, via at least one processor communicatively coupled to a memory, event-driven booking data from at least one travel supplier system, using one or more application programming interfaces, the event-driven booking data being generated in response to a travel booking creation, modification, cancellation, or partial fulfilment;
parsing and normalizing, via the at least one processor, the event-driven booking data to generate a standardized unused travel value object comprising at least a monetary value, expiration data, traveller identification data, enterprise association data, and supplier-specific usage constraints, using a supplier-agnostic data processing module;
storing, via the at least one processor, the standardized unused travel value object in a centralized value ledger maintained in the memory, wherein the centralized value ledger is a continuously synchronized data structure configured to track a lifecycle state of each standardized unused travel value object comprising at least available, assigned, consumed, expired, or forfeited states;
determining, via the at least one processor, based at least on enterprise policy rules, traveller identity data, and organizational group membership, a set of eligible candidate travellers within an enterprise for assignment of the standardized unused travel value object;
executing, via the at least one processor, an allocation determination process configured to automatically rank and select, from the set of eligible candidate travellers, a candidate traveller for assignment of the standardized unused travel value object based on predicted utilization and expiration avoidance, using a machine-learning based allocation engine;
assigning, via the at least one processor, the standardized unused travel value object to the selected candidate traveller by updating the centralized value ledger without exposing supplier-originated credit identifiers or redemption credentials to the selected candidate traveller, thereby enforcing enterprise-only usage and preventing unauthorized external transfer;
determining, via the at least one processor, in real time and prior to a checkout transaction, traveller eligibility for use of the assigned standardized unused travel value object by applying an authorization model that evaluates traveller identity data, enterprise policy rules, booking channel attributes, and the supplier-specific usage constraints associated with the standardized unused travel value object; and
transmitting, via the at least one processor, upon determining traveller eligibility, the assigned standardized unused travel value object to a checkout system of the at least one travel supplier system during a booking workflow such that the standardized unused travel value object is automatically surfaced and applied during checkout without requiring manual credit entry by the traveller.
